(19) United States
(12) Patent Application Publication
(10) Pub. No.: US 2010/0247893 A1
(43) Pub. Date: Sep. 30, 2010

(54) High quality luminescent materials for solid state lighting applications

(75) Inventor: Scott M. Zimmerman, Basking Ridge, NJ (US)

Correspondence Address: Goldeneye, Inc., Suite 233, 9747 Businesspark Avenue, San Diego, CA, 92131, US

(73) Assignee: Goldeneye, Inc.

(21) Appl. No.: 12/383,567

(22) Filed: Mar. 25, 2009

(51) Int. Cl. C09K 11/08; B32B 5/02

(52) U.S. Cl. 428/292.1; 252/301.4 R

(57) ABSTRACT

High thermal conductivity fiber, flake, elongated particle, and belts, which exhibit luminescent properties, are fillers within a matrix to form solid luminescent elements. The use of sol-gel, sintering, melt, and high pressure firing consolidates these materials. Articles constructed from the solid luminescent element can be used in lighting, displays and other semiconductor applications.

### BACKGROUND OF THE INVENTION

Phosphor powders dominate the solid state lighting market presently. This technology dates back over 100 years and is primarily based on solid state processing of compounds. A variety of inorganic materials are mixed in powder form, fired/sintered in a variety of manners, and then ground into powders. While this approach is cost effective, it is difficult to create high purity materials and to prevent the introduction of contaminates. In addition, the quality of the starting materials also creates difficulty with this approach.

Powdered phosphor approaches become the limiting factor in performance when very high flux levels are required. This limiting factor is driven by the efficiency of the phosphor and also by the thermal load the phosphor experiences. Because there is no reasonable thermal conduction path for the phosphors, the heat generated within the phosphor particles can exceed several hundred degrees C. in high powered applications. This lack of thermal conduction leads to thermal quenching of the phosphor and also degrades the surround matrix that contains the phosphor powders. The combination of heat and humidity can easily degrade the organic matrix typically used in these applications. This present invention discloses thermally conductive luminescent composites, which overcome these issues.

The creation of a thermally conductive luminescent element allows for increased lumens/cc³ of luminescent material. In the case of powdered phosphors, a reduced flux density is required to prevent thermal quenching; this reduced flux density dictates that more phosphor material is needed to generate a given amount of lumens. Given the finite supply of rare earth materials, there is a need for more efficient usage of those resources if general illumination is to be based on solid state approaches.

The purpose of this present invention is to create very high quality luminescent materials in the form of nano and micro fibers. More preferably, CVD techniques form high crystal quality fibers as well as other particles shapes and their consolidation into solid luminescent elements for use in solid state lighting applications. Even more preferably, anisotropic fibers serve as both luminescent elements and high thermal conductivity fillers within a solid luminescent element. Thermal conductivity and luminescence are a function of crystal quality. This is especially true of the high temperature oxide, nitrides, and oxynitrides. It is therefore the intent of this invention to disclose luminescent fibers and other particle shapes, which have an enhanced thermal conductivity and luminescence due to their method of formation.

Additionally, the surface characteristics of these materials are more stable than powdered based approaches and have reduced surface defects, which further enhance life. Barrier coatings are added during formation an/or after the formation of these luminescent fibers and other particle shapes to further increase the stability of the materials.

### SUMMARY OF THE INVENTION

This invention discloses the use of high thermal conductivity fiber, flake, elongated particle, and belts, which exhibit luminescent properties as fillers within a matrix to form solid luminescent elements. The use of sol-gel, sintering, melt, and high pressure firing consolidates these materials either in the presence of additional elements or singly. More preferably, the use of the luminescent filler fibers and other particle shapes, enhance mechanical and thermal properties of the resulting substantially solid luminescent element. More preferably, the formation of luminescent filler fibers and other particle shapes exhibit dimensionality on the order of the wavelength of the emitted light and their use in forming high efficiency substantially luminescent elements.

The formation of solid luminescent filler elements exhibit reduced backscatter or controlled scatter based on the consolidation characteristics of nano and micro fibers and other particle shapes. The luminescent filler fibers and other particle shapes are oriented via mechanical, magnetic, electrical, and self assembly means including but not limited to solvent evaporation and/or usage of templates. Graded luminescent filler fibers as well as other shapes are formed whereby the dopant concentration, dopant type and/or lattice matrix is varied during the growth cycle.

In general, this approach can create superior luminescent materials to more conventional solid state processes due to the higher purity of the starting materials, decreased contamination of the processing, and the elimination of any subsequent grinding processes which tend to introduce contaminates. Articles constructed from the solid luminescent element can be used in lighting, displays and other semiconductor applications.

### BRIEF DESCRIPTION OF THE DRAWINGS

FIG. 1 is a side view of a typical LED with powder phosphor coating.

FIG. 2 is a graph of thermal conductivity versus dislocation density (e.g. crystal quality) for gallium nitride.

FIG. 3 is a perspective view of a CVD grown doped luminescent filler fiber according to the present invention.

FIG. 4 is a perspective view of a HVPE grown, laser scribed, lifted off luminescent filler flake according to the present invention.

FIG. 5 is a side view of a ceramic composite containing at least one type luminescent fiber according to the present invention.

FIG. 6 is a side view of a solid luminescent element containing at least one luminescent flake and one luminescent fiber attached to at least one light emitting diode according to the present invention.

FIG. 7 is a perspective view of luminescent nanofibers oriented within a solgel solid exhibit anisotropic thermal conductivity according to the present invention.

FIG. 8 is a side view of an oriented array of micro flakes attached to at least one light emitting diode according to the present invention.

FIG. 9 is a perspective view of a nanofiber exhibiting a glassy coating that provides for both enhanced stability and allows for melt bonding according to the present invention.

FIG. 10 is a side view of a matrix of luminescent fibers and other particle shapes coated with a glassy coating and consolidated via a high temperature lamination step attached to at least 1 light emitting diode according to the present invention.

### DETAILED DESCRIPTION OF DRAWINGS

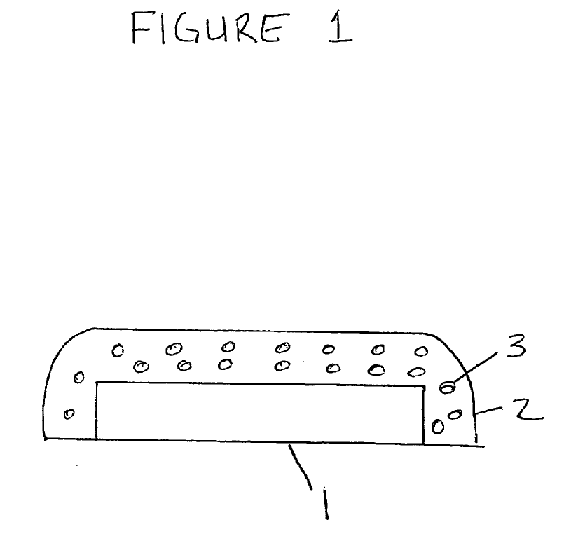

FIG. 1 depicts a typical LED 1 coated with a phosphor powder 3 within an encapsulation 2. The lack of a reasonable thermal conduction path for the phosphor powder leads to thermal quenching at high flux levels. Additionally, most luminescent materials exhibit relatively high index of refraction relative to encapsulation 2 and therefore exhibit high backscatter. Attempts to reduce backscatter through the use of high index of refraction materials for encapsulation 2 and reduced particle sizes for phosphor powder 3 have had limited success due to excessive yellowing of these types of encapsulants and reduced efficiency of phosphor powders as they are ground to smaller particle sizes. While nanophosphors have been developed, they tend to only be effective in low concentrations due to quenching effects. In addition, the high surface area to bulk ratio of nanoparticles can lead to degradation of the nanoparticles themselves and/or degradation of the encapulation 3 due to catalytic effects. Lastly, any micro or nano solution must be properly contained within a stable matrix to prevent any safety issues associated with inhalation of these particles throughout the life and disposal of the light source. This is especially true of nanoparticles, which contain heavy metals as typically used in quantum dots. The need therefore exists for efficient, highly stable, safe, luminescent elements, which can be used in high flux solid state lighting applications.

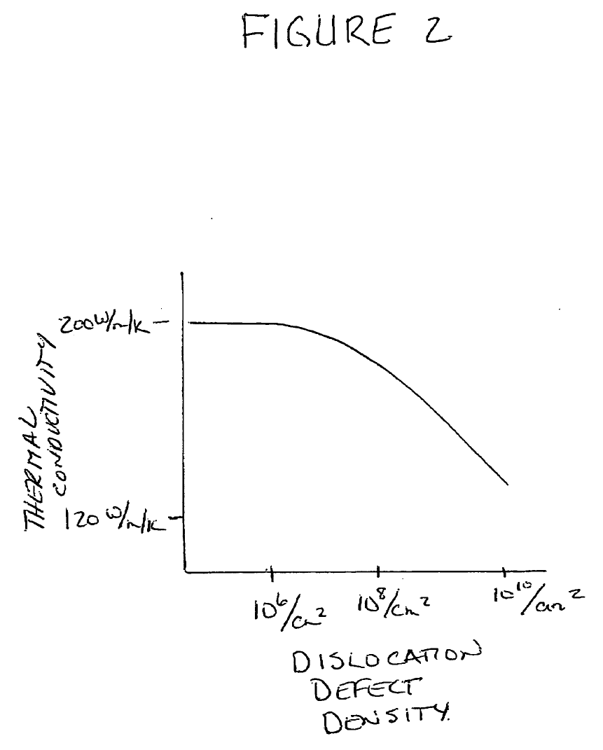

FIG. 2 shows the relationship between crystal quality and thermal conductivity for gallium nitride as a function of dislocations/cm² specifically. In general, increasing crystal quality enhances thermal conductivity. Increased crystal quality can also lead to enhanced luminescent properties and reduced self absorption. The use of chemical vapor deposition (CVD) techniques to grow high quality nano and micro fibers offers one route to enhanced crystal quality. These CVD techniques provide for reduced impurities within the crystal, which allows increases thermal conductivity and improved luminescent properties. In addition, the shape and size of the nano or microfibers can lead to enhanced extraction efficiency relative to a bulk material. The ability to use growth techniques such as, but not limited to, CVD, HVPE, evaporation, and sputtering as known in the art to create improved luminescent materials, harvesting those materials, and consolidating those materials either singly or with other materials to form solid luminescent elements is an embodiment of this invention.

Luminescent element fillers are bound in a matrix to form the luminescent element.

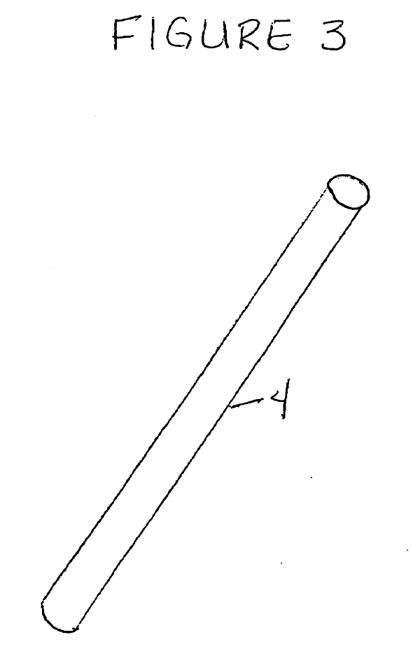

FIG. 3 depicts a luminescent element filler 4 based on, but not limited to, oxides, nitrides, oxynitrides, Sialons, and silicates. This luminescent element filler 4 may contain, but are not limited to, rare earth dopants, quantum dots, caged ions, and other luminescent species. A variety of shapes for the luminescent element 4 include, but are not limited to, fibers, belts, discs, corkscrews, and rods. Preferably, the luminescent element filler 4, which are fiber-like in shape, exhibits a diameter less than 10 micrometers and length to diameter ratio greater than 1. More preferably, fiber-like luminescent element filler 4 exhibits a diameter less than 1 micrometers and length to diameter ratios greater than 10. One or a plurality of fibers can be used as the filler. The use of quantum confinement and/or shape which enhance extraction or which creates directionality within the fiber of other shapes is an embodiment of this invention.

The spectral emission of the dopant and/or luminescent element filler 4 can be modified using quantum confinement effects. Quantum confinement effects may include, but are not limited to, formation of photonic crystal structures both on the exterior and interior of the luminescent element filler 4 and the formation of quantum dot based structures within the bulk of the luminescent element filler 4. Variable dopants and/or other luminescent elements can be used along the length of the luminescent element filler 4 by the modification of the growth conditions. In this manner, a broader emission range can be created within a luminescent element filler 4. A preferred embodiment of luminescent element filler 4 is a graded luminescent fiber, which can be tailored to a wide range of emission spectra. Dopant concentration, dopant species, and/or changes in lattice composition can all be modified using this approach to create the desired emission spectra within a single fiber or other shape. By varying these parameters during the growth of luminescent element, the emission spectra can be substantially different within the same luminescent element filler 4. This enables a more continuous emission spectra, reduced losses due to backscatter, reduced color variation across the light source and tighter color control of the emission spectra from a given luminescent element filler 4.

Graded luminescent fibers as well as other shapes are formed whereby the dopant concentration, dopant type and/or lattice matrix is varied during the growth cycle. The graded luminescent fibers will have the same base material but with two or more different dopants. As an example, a ZnO single crystal fiber can be grown on a sapphire wafer. Different dopants are introduced as the fiber grows. Zn doped ZnO could be followed by Bi doped ZnO, followed by S doped ZnO. Because the growth is sequential and substantially in one direction, the resulting fiber would emit green, orange and red wavelengths simultaneously. The ratio of the different wavelengths would be based on the percentage of volume associated with each dopant and the efficiency of each particular dopant to the excitation used. The high index nature of most materials made by this method would tend to light pipe the light generated within the fiber such that fairly uniform mixing would occur even within each individual fiber.

The incorporation of quantum dots into the luminescent element filler 4 during growth is also an embodiment of this invention. In general, the luminescent element filler 4 may be comprised of a phosphor material, a quantum dot material, a luminescent dopant material or a plurality of such materials. The luminescent element filler 4 may be a doped single-crystal solid, a doped polycrystalline solid or a doped amorphous solid. A preferred embodiment is a substantially single crystal luminescent element filler 4, which grows substantially in one direction or plane. Examples of this may include, but are not limited to, rods, fibers, platelets, discs, and belts. In this manner, the emission spectra of the luminescent element filler 4 can be varied as the luminescent element filler 4 grows outward. Materials used for the luminescent element filler 4 may consist of inorganic crystalline, polycrystalline or amorphous materials doped with ions of lanthanide (rare earth) elements or, alternatively, ions such as manganese, magnesium, chromium, titanium, vanadium, cobalt or neodymium. The lanthanide elements are lanthanum, cerium, praseodymium, neodymium, promethium, samarium, europium, gadolinium, terbium, dysprosium, holmium, erbium, thulium, ytterbium and lutetium. These dopants maybe doped within lattice materials include, but are not limited to, sapphire (Al₂O₃), gallium arsenide (GaAs), beryllium aluminum oxide (BeAl₂O₄), magnesium fluoride (MgF₂), indium phosphide (InP), gallium phosphide (GaP), any garnet material such as yttrium aluminum garnet (YAG or Y₃Al₅O₁₂) or terbium-containing garnet, yttrium-aluminum-lanthanide oxide compounds, yttrium-aluminum-lanthanide-gallium oxide compounds, yttrium oxide (Y₂O₃), calcium or strontium or barium halophosphates (Ca,Sr,Ba)₅(PO₄)₃(Cl,F), the compound CeMgAl.₁₁O₁₉, lanthanum phosphate (LaPO₄), lanthanide pentaborate materials ((lanthanide)(Mg,Zn)B₅O₁₀), the compound BaMgAl₁₀O₁₇, the compound SrGa₂S₄, the compounds (Sr,Mg,Ca,Ba)(Ga,Al,In)₂S₄, the compound SrS, the compound ZnS, ZnO alloys (Cd, Mg, Ga, In, Si), nitride alloys (Al, Ga, In, As, P, B, Mg, Si) and nitridosilicate. There are several exemplary phosphors that can be excited at 250 nanometers or thereabouts. An exemplary red emitting phosphor is Y₂O₃:Eu³⁺. An exemplary yellow emitting phosphor is YAG:Ce³⁺. Exemplary green emitting phosphors include CeMgAl₁₁O₁₉:Tb³⁺, ((lanthanide)PO₄:Ce³⁺,Tb³⁺) and GdMgB₅O₁₀:Ce.³⁺,Tb³⁺. Exemplary blue emitting phosphors are BaMgAl.₁₀O₁₇:Eu²⁺ and (Sr,Ba,Ca)₅(PO₄)₃Cl:Eu²⁺. For longer wavelength LED excitation in the 400 to 500 nanometer wavelength region or thereabouts, exemplary optical inorganic materials include yttrium aluminum garnet (YAG or Y₃Al₅O₁₂), terbium-containing garnet, yttrium oxide (Y₂O₃), YVO₄, SrGa₂S₄, (Sr,Mg,Ca,Ba)(Ga,Al,In)₂S₄, SrS, and nitridosilicate. Exemplary phosphors for LED excitation in the 400 to 500 nanometer wavelength region include YAG:Ce³⁺, YAG:Ho³⁺, YAG:Pr³⁺, SrGa₂S₄:Eu²⁺, SrGa₂S₄:Ce³⁺, SrS:Eu²⁺ and nitridosilicates doped with Eu²⁺. Alloys of ZnO are preferred lattice materials especially degeneratively doped alloys containing (Zn, Al, In, Ga, Mg, S, Se) dopants, which are electrically conductive as well as luminescent. More preferred embodiments are ZnO alloys, which contain Bi, Li, and Na to extend the excitation spectrum down into the near UV/blue. Quantum dot materials are small particles of inorganic semiconductors having particle sizes less than about 40 nanometers. Exemplary quantum dot materials include, but are not limited to, small particles of CdS, CdSe, ZnSe, InAs, GaAs and GaN. Quantum dot materials can absorb light at one wavelength and then re-emit the light at different wavelengths that depend on the particle size, the particle surface properties, and the inorganic semiconductor material. Sandia National Laboratories has demonstrated white light generation using 2-nanometer CdS quantum dots excited with near-ultraviolet LED light. Efficiencies of approximately 60% were achieved at low quantum dot concentrations dispersed in a large volume of transparent host material. Because of their small size, quantum dot materials dispersed in transparent host materials exhibit low optical backscattering. Luminescent dopant materials include, but are not limited to, organic laser dyes such as coumarin, fluorescein, rhodamine and perylene-based dyes. Other types of luminescent dopant materials are lanthanide dopants, which can be incorporated into polymer materials. The lanthanide elements are lanthanum, cerium, praseodymium, neodymium, promethium, samarium, europium, gadolinium, terbium, dysprosium, holmium, erbium, thulium, ytterbium and lutetium. An exemplary lanthanide element is erbium. The luminescent element filler 4 may be transparent, translucent or partially reflecting. The optical properties of the luminescent element filler 4 depend strongly on the materials utilized and the surrounding matrix to be discussed later. A luminescent element filler 4 containing particles that are much smaller than the wavelengths of visible light and that are dispersed in a transparent host material may be highly transparent or translucent with only a small amount of light scattering. A luminescent element filler 4 that contains particles that are approximately equal to or larger than the wavelengths of visible light will usually scatter light strongly. Such materials will be partially reflecting. If the luminescent element filler is partially reflecting, it is preferred that the luminescent element filler be made thin enough so that it transmits at least part of the light incident upon the luminescent element filler. Most preferably, the graded luminescent element filler 4 dopants type and/or concentration is varied as it is growth such that a substantially continuous emission spectra is generated and is used to create a broadband emission spectrum suitable for white light applications.

The method of forming this variable dopant via chemical vapor deposition (CVD) or other luminescent element filler 4 producing methods is an embodiment of this invention. The methods of monitoring and controlling this variable doping method during luminescent element filler 4 growth are also embodiments of this invention. The resulting luminescent element fillers 4, the resulting luminescent bulk after consolidation, and the use of these articles with at least one light emitting diode are embodiments of this invention. Arrays based on these articles can form large area light sources, or backlights. The deposition of interconnects and other addressing means to form fixed and actively addressed regions based on these articles are embodiments. The resulting articles can be used as signage, displays, and signals.

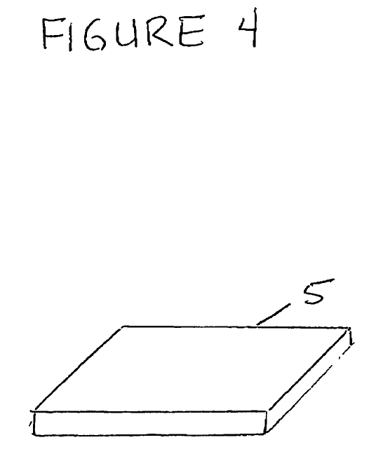

FIG. 4 depicts a phosphor flake formed via HVPE on a sapphire wafer, which was subsequent diced via laser streeting and then removal of the sapphire via laser liftoff. The resulting high aspect ratio flake 5 can be used singly as a filler, or multiple flakes can be used as the filler, or as a filler element within a consolidating matrix to form a solid luminescent element. A variety of shapes for the flake can be formed, including but not limited to, squares, circles, irregular shapes and strips. A flake thickness of less than 10 microns is preferred. More preferably the flake thickness is less than 1 micron.

The incorporation of the variable dopants as discussed previously is also an embodiment of this invention. This may be accomplished, but is not limited to, selective implantation, screening methods, or the use of spin on dopants. Additionally, multiple stacked high aspect ratio flakes 5 can be used to form vertically layered filler elements. More preferably, this layered luminescent bulk filler element can be formed with laser and mechanical trimming techniques to balance both color and intensity over an area. Extraction elements can be introduced on the surface and within the bulk of the high aspect ratio flake 5. This may be accomplished by, but not limited to, laser patterning, lithography and etching techniques as known in the art.

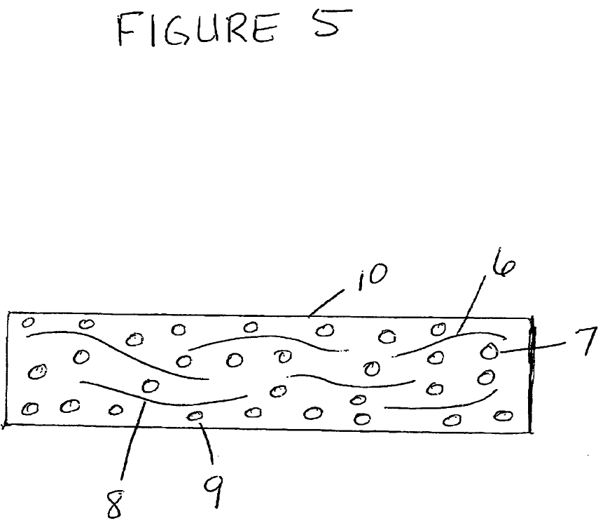

FIG. 5 depicts the consolidation of the both filler powders 7 and 9 and filler fibers 6 and 8 into a substantially solid luminescent element. The matrix 10 may consist of, but is not limited to, inorganic or organic materials. More preferably, matrix 10 is inorganic. The transparent host materials include polymer materials and inorganic materials. The polymer materials include, but are not limited to, acrylates, polystyrene, polycarbonate, fluoroacrylates, perfluoroacrylates, fluorophosphinate polymers, fluorinated polyimides, polytetrafluoroethylene, fluorosilicones, sol-gels, epoxies, thermoplastics, thermosetting plastics and silicones. Fluorinated polymers are especially useful at ultraviolet wavelengths less than 400 nanometers and infrared wavelengths greater than 700 nanometers owing to their low light absorption in those wavelength ranges. Exemplary inorganic materials include, but are not limited to, silicon dioxide, optical glasses and chalcogenide glasses. All elements described above may exhibit luminescence or may be non-luminescent. A variety of luminescent materials are mixed to create a specific color temperature or color upon excitation. The use of this material with trimming techniques is also an embodiment of this invention. A preferred embodiment is based on inorganic glasses for the matrix 10 due to higher thermal conductivity and stability of inorganics versus organic materials in a high light flux environment.

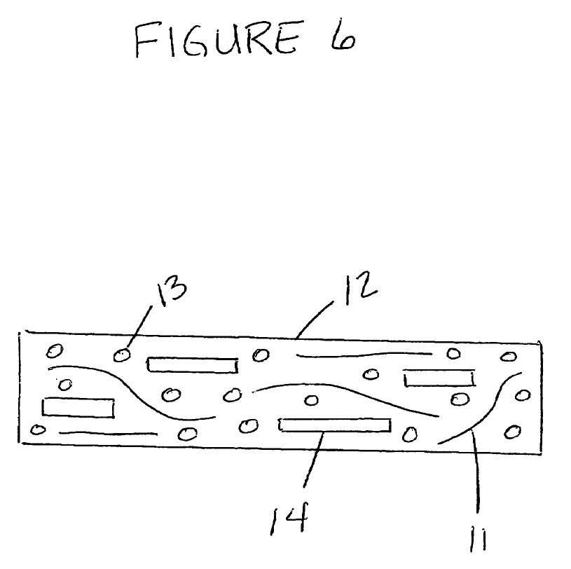

FIG. 6 depicts the formation of a substantially solid luminescent element containing filler flakes 14, filler powders 13, and filler fibers 11. At least one of these elements is luminescent. A matrix 12 enhances the mechanical, thermal, optical, adhesion, and/or electrical characteristics of the substantially solid luminescent element. The ability to create enhanced thermal conductivity luminescent materials exhibiting high aspect ratios and their use to enhance physical properties such as, but not limited to, crack resistance, thermal conductivity, flexure strength, and overall toughness is an embodiment of this invention. Size and enhanced sintering characteristics are used to form translucent to transparent substantially solid luminescent elements.

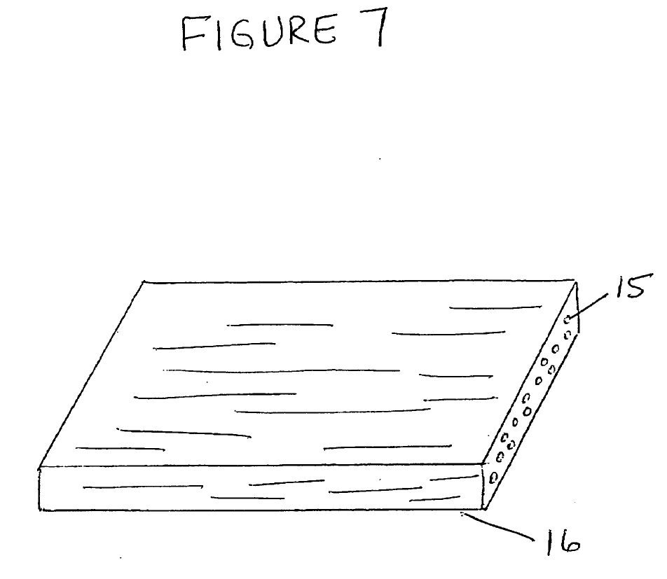

FIG. 7 depicts an anisotropically oriented composite of luminescent filler fibers 15 contained with a matrix 16. In a manner similar to a printed circuit board laminate, the fibers provide enhanced structural, thermal and electrical properties to the matrix 16 as well as the luminescent properties inherent to the fibers 15. The matrix 16 most preferably is minimized with the majority of the substantially solid luminescent element being fibers. Consolidation means. as known in the art. include, but are not limited to, pressing, tape casting, rolling, and melt bonding. The addition of external metal foils that can be removed via subtracted means as practiced in the printed circuit board industry are also embodiments of this invention. In this manner, a luminescent interconnect can be realized. The luminescent fibers 15 will serve both as luminescent elements and expansion control elements in this application.

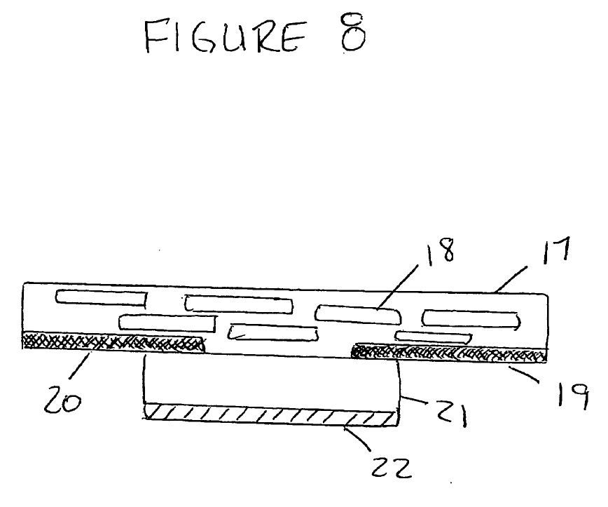

FIG. 8 depicts a substantially solid luminescent element formed with at least one luminescent filler flake 18. The luminescent filler flakes 18 can be consolidated with or without matrix 17. LED 21 is reverse flip chip mounted to resulting substantially solid luminescent element via metal contacts 19 and 20. This results in a chip scale package in which electrical contact is made to the LED 21 either via contacts 19 and 20 for a coplanar device or via contacts 19, 20 and 22 for a vertical device. Reflective contact means can be used for contacts 19, 20, and/or 22 including, but not limited to, omnidirectional reflectors, highly reflective metals, transparent conductive oxides, and the fibers both luminescent and non-luminescent with the substantially solid luminescent element. More preferably, the use of electrically conductive luminescent fibers such as doped ZnO, GaN, and other intrinsically conductive materials are embodiments of this invention. This approach enhances device performance by reducing absorption losses especially in the case of large area arrays by eliminating or reducing the amount of opaque contacts within the structure.

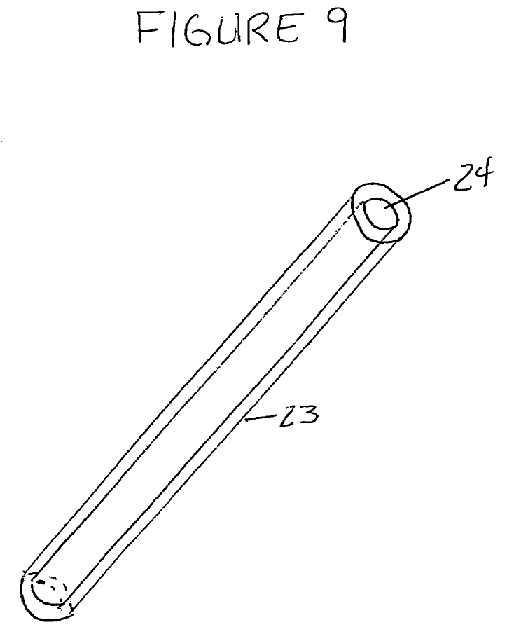

FIG. 9 depicts a luminescent filler fiber 24 with an additional coating 23 on the outside periphery of the luminescent filler fiber 24. This coating may include, but not limited to, melt bondable materials, additional luminescent layers, transparent electrically conductive layers, surface roughening layers for extraction enhancements, and protective coatings to enhance the optical, electrical, environmental or bonding/sintering characteristics. Surface treatments aid in the dispersal of the fibers into a matrix using both hydrophobic and hydroscopic means. The use of this technique for all disclosed shapes is also an embodiment. Coating methods can be in situ to the growth or via post processing including dip coating, spray coating, and evaporation techniques as known in the art. This approach enables the formation of composites with a minimal amount of additional coating 23 required to form a substantially solid element. The use of graded filler luminescent elements as previously discussed for luminescent filler fiber 24 is a preferred embodiment of this invention.

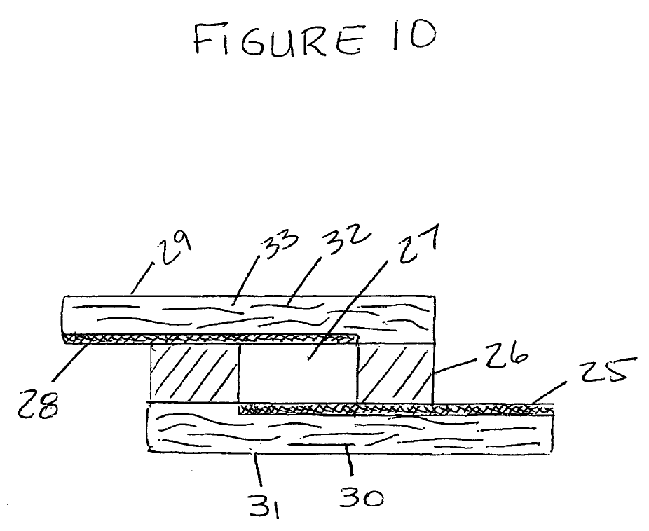

FIG. 10 depicts an embedded LED 27 captured between substantially solid luminescent layers 29 and 31, which consist mainly of glass coated luminescent filler fibers 30 and 32. More preferably, these fibers 30 and 32 are melt bondable. Pressure and temperature can melt bond the high thermal conductivity luminescent filler fibers 31 and 32. The addition of matrix 33, either organic or inorganic, is also a preferred embodiment. The resulting luminescent printed circuit board may additionally contain interconnect means 25 and 28 which may be deposited via a variety of means as known in the art including, but not limited to, metal foils, evaporation, thick film printing, and a other coating methods for both opaque and transparent electrical conductive layers. Printing and lithography means can be used to define the interconnect means 25 and 28. Additionally a dielectric buffer layer 26 can isolate the interconnect contacts 28 and 25.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A luminescent element comprising
a matrix, and
a luminescent filler bound in said matrix, said luminescent filler being at least one luminescent fiber.

2. The luminescent element of claim 1 wherein said at least one luminescent fiber has a diameter and a length such that said diameter of said at least one luminescent fiber is less than 10 micrometers and said at least one luminescent fiber has a length to diameter ratio greater than 1.

3. The luminescent element of claim 2 wherein said diameter of said at least one luminescent fiber is less than 1 micrometers and said at least one luminescent fiber has a length to diameter ratio greater than 10.

4. The luminescent element of claim 1 wherein said at least one luminescent fiber and said matrix form a composite luminescent element.

5. The luminescent element of claim 4 wherein a majority of said composite luminescent element is said at least one luminescent fiber

6. The luminescent element of claim 1 wherein said at least one luminescent fiber has a coating of melt bondable materials, additional luminescent layers, transparent electrically conductive layers, surface roughening layers for extraction enhancements, or a protective coating.

7. A luminescent element comprising
a matrix, and
a graded luminescent filler bound in said matrix, said graded luminescent filler having the same base material and two more different dopants.

8. A luminescent element comprising
a matrix, and
a luminescent filler bound in said matrix, said luminescent filler being at least one flake.

9. The luminescent element of claim 8 wherein multiple flakes form at least one vertically layered luminescent filler.
